(19) United States
(12) Patent Application Publication
(10) Pub. No.: US 2010/0332278 A1
(43) Pub. Date: Dec. 30, 2010

(54) PROJECT MANAGEMENT VIA COLLABORATIVE CALENDARING

(76) Inventors: Edith H. Stern, Yorktown Heights, NY (US); Barry E. Willner, Briarcliff Manor, NY (US); Robert C. Weir, Westford, MA (US); Patrick J. O'Sullivan, Dublin (IE)

Correspondence Address: MOORE & VAN ALLEN, PLLC For IBM, P.O. Box 13706, Research Triangle Park, NC, 27709, US

(21) Appl. No.: 12/491,490

(22) Filed: Jun. 25, 2009

(51) Int. Cl. G06Q 10/00

(52) U.S. Cl. 705/9

(57) ABSTRACT

An apparatus and method for collaborative calendaring of event management that includes receiving data of a desired calendar event, receiving data of a desired objective related to the desired calendar event, and providing an indication of at least one other calendar event responsive to receiving the indication of the desired objective. The indication of the at least one other calendar event may be provided based on a template associated with the desired objective. The template may define best practices events related to the objective.

### BACKGROUND OF EMBODIMENTS OF THE INVENTION

The present invention is related to project management, and more specifically to project management via collaborative calendaring.

Currently, businesses, organizations and individuals use various tools to help them in their jobs, activities, or tasks. For example, adding things to a calendar or “calendaring items” allows individuals to attach activities, events, milestones, etc. to specific dates and times. Further, other tools such as project management tools help plan schedules, identify bottlenecks and provide views of impending problems. However, project management tools tend to be heavyweight approaches unsuitable for smaller projects. Further, current methods do not provide enforcement or assistance with helping users/businesses to comply with certain desired structures or best business practices that may help simplify a task, make it more efficient, or take much of the work from the user/business. Currently, enforcement of best practices policies for tasks or activity management such as project management is a manual process involving an increased number of administrative staff for overall management such as setting up meetings, schedules, plan modifications, etc.

### BRIEF SUMMARY OF EMBODIMENTS OF THE INVENTION

According to one aspect of the present invention, a method for collaborative calendaring of event management that includes receiving data of a desired calendar event, receiving data of a desired objective related to the desired calendar event, and providing an indication of at least one other calendar event responsive to receiving the data of the desired objective.

According to another aspect of the present invention, a computing device includes a network interface, the network interface being configured to receive data of a desired calendar event and data of a desired objective related to the desired calendar event, a storage device, the storage device containing at least one template associated with an objective, and a processor, the processor entering the received data of the desired calendar event, processing the received data of the desired objective, and providing an indication of at least one other calendar event responsive to processing the data of the desired objective.

According to a further aspect of the present invention, is included a computer program product comprising a computer readable storage medium, the computer readable storage medium having computer readable program code embodied therewith, the computer readable storage medium that includes computer readable program code configured to receive data of a desired calendar event, computer readable program code configured to receive data of a desired objective related to the desired calendar event, and computer readable program code configured to provide an indication of at least one other calendar event responsive to receiving the indication of the desired objective.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for collaborative categorizing according to an exemplary embodiment of the present invention;

FIG. 2 is a flowchart of a process for collaborative calendaring of event management according to an exemplary embodiment of the present invention;

FIG. 3 is a flowchart of a process for collaborative calendaring of event management according to another exemplary embodiment of the present invention;

FIG. 4 is a flowchart of a process for collaborative calendaring of event management according to a still further exemplary embodiment of the present invention; and

FIG. 5 is a flowchart of a process for collaborative calendaring of event management according to a still further exemplary embodiment of the present invention.

### DETAILED DESCRIPTION OF EMBODIMENTS OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

To help illustrate embodiments of the present invention a project management task will be used however collaborative categorizing embodiments according to the present invention are not limited to this type task as any type task, project, event, etc. are within the scope of the present invention.

According to embodiments of the present invention, calendar events, such as meetings and reminders may be associated with projects and may be used to trigger and initiate project management activities. For example, calendar events may trigger compliance with project management best practices, therefore, making such practices available to a general calendar used by an enterprise, business or organization's population or employees. This reduces the number of administrative staff and helps to simplify project management tasks for a user.

According to embodiments of the present invention, a user who desires to put together a task, project, event, etc. may select a calendaring option for project management from a menu or graphical user interface (GUI) of a collaborative calendaring system where the option allows the user to specify individuals to be invited to various meetings that may be set up, as well as their associated roles. Selection of a calendaring option for project management may also invoke a project template. The template may be associated with the desired task of the user and may contain set milestones, tasks, activities, reviews, timeframes, etc. related to a specific project type. The collaborative calendaring system, responsive to the template invoked, may request additional information to be input to help further identify beneficial milestones, actions, meetings, etc. For example, additional information may include brief milestone titles, milestone owners, target dates, milestone dependencies, additional milestone roles to be specified (e.g., reviews), organizational reviews required, number or frequency of desired interim tracking points, a final deadline, etc. A collaborative calendaring system may then initiate status meetings, reminders, interim check points, and project reviews based on the template and the input(s) received from the user. The collaborative calendaring system may check calendars for project management participants in order to optimize the scheduling. The system may also take into account weekends and holidays. Reminders may optionally be generated, for example, to the milestone owner as well as participants, meeting invitees, or others.

Moreover, according to embodiments of the present invention, a milestone owner (one responsible for meeting the milestone) may be queried via email to see whether the milestone has occurred on time. If the milestone is delayed, a notification may be sent to the project manager, and other affected milestone dates may be modified automatically, and any review meetings rescheduled. In certain embodiments according to the present invention, a project manager or other user may be required to verify completion of a milestone, or to verify meeting rescheduling. Calendared event movement, completion, delay, etc. that affect one or more other calendared events or project deadlines, may trigger reassessment or modification of other calendared items such as interim dates, related activities, etc.

In some embodiments according to the present invention, from any calendar entry related to a project there may be easy access to a view of the project as a whole. This view may include information such as, for example, finished project steps, project steps to be done, responsible persons, project status, etc. In embodiments according to the present invention, a project may include steps that happen automatically (for example, publication of successful milestones) and are not limited to actions of people. In still other embodiments according to the present invention, calendar entries associated with project steps may not be placed on the calendar on the successful conclusion of earlier steps. In addition, according to embodiments of the present invention, scheduling of calendaring events associated with a project may be made a tentative and may be moved based on rules associated with priorities, ranking, organizational behavior, etc.

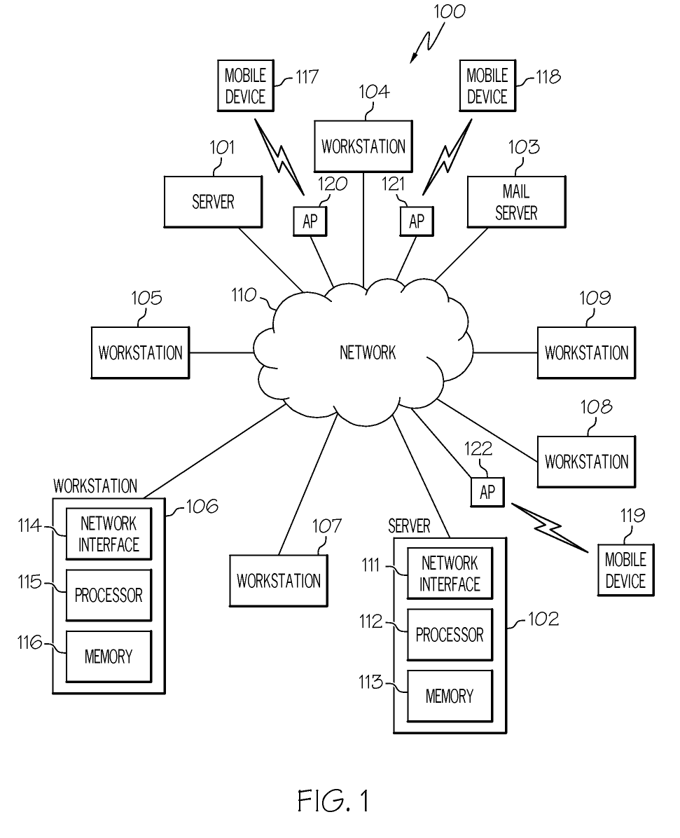

FIG. 1 shows a diagram of a system for collaborative categorizing according to an exemplary embodiment of the present invention. A system 100 may include one or more servers 101, 102, one or more mail servers 103, one or more wireless devices 117-119, and one or more workstations 104-109, where the servers 102, 102, wireless devices 117-119, and workstations 104-109 may be interconnected via a network 110. The wireless devices 117-119 may access the network 110 via one or more access points 120-122 or by any other common method. The wireless devices 117-119 may be any type of wireless device such as, for example, a mobile phone, a personal digital assistant (PDA), a portable game system, a laptop computer, etc. The network 110 may be the Internet, an intranet, a local area network, a wide area network, or any other type of network. Each server 101, 102, 103 may include a network interface 111, a processor 112, a memory 113, and other elements normally associated with a server. Similarly, each workstation 104-109 may include a network interface 114, a processor 115, and memory 116, and other items normally associated with a workstation.

The network interface 111 of a server 101, 102, 103 may be configured to receive data of a desired calendar event and data of a desired objective related to the desired calendar event from a workstation 104-109 via the network 110. The memory 113, 116 (or storage device) may store at least one template associated with an objective. The processor 112, 115 may be configured to enter the received data of the desired calendar event, process the received data of the desired objective, and provide an indication of at least one other calendar event responsive to processing the data of the desired objective. The processor may also calendar the desired calendar event and the at least one other calendar event responsive to receiving authorization to calendar the desired calendar event and the at least one other calendar event. The processor may also calendar the desired calendar event and the at least one other calendar event automatically. The processor may automatically modify at least one of the at least one other calendar events responsive to one or more of a dependency, a delay, a calendar of a person, a calendared event occurring on a holiday, a calendared event occurring on a Saturday or Sunday, an unmovable deadline, a milestone occurring, or a milestone being missed. The processor may initiate one or more actions in accordance with the at least one other calendar event. The at least one action may include one or more of calendaring a new event, initiating a meeting with at least one person, sending a reminder to at least one person regarding at least one of the calendared events, defining and calendaring a checkpoint regarding at least one of the calendared events, defining and calendaring a dependency regarding at least one of the calendared events, or defining and calendaring a project review. The indication of the at least one other calendar event may be provided based on a template associated with the desired objective.

Users may access and review the calendar from their workstations. The actions initiated by the server 101 may include, for example, setting up meetings, defining milestones, sending emails to appropriate people, sending invites to meetings to appropriate people, modifying a calendar events based on milestones being met, modifying a calendar events based on deadlines being missed, identifying and resolving conflicts with one or more persons' schedules, or any other actions related to the calendared events, goals of the user the desired calendared activity and/or the objective to be met.

Further, the server 101 may have access to the calendars of appropriate individuals related to the task or project and may resolve any conflicts by accessing these individuals' calendars and adjusting calendar events based on existing conflicts with one or more persons' calendars. A user's calendar may be accessed from the user's workstation, may reside at the server, or may reside in some other location accessible by the server 101 either over a network or otherwise.

Further, the server 101 may access a database of templates that comprise typical milestones, events, tasks, actions, responsible person titles, etc. associated with different types of objectives, projects or goals. These templates may be stored in a database at the server 101 or stored in any location accessible by the server 101. Once a template is selected, the collaborative calendaring system may issue prompts to a user requesting additional information in order for the server 101 to identify and generate calendared events to make operation of a task or project more efficient for the user. Upon receipt of the additional information, the server 101 may then calendar additional events responsive to receiving the additional information in response to the template options.

Moreover, the server 101, as noted previously, may modify one or more of the calendared events based on any number of situations such as, for example, a dependency being identified, a delay being identified, an event occurring on a holiday or weekend, an unmovable deadline being identified, a milestone being identified as having occurred, a milestone identified as having been missed, etc. Upon detection of any of these events or occurrences, the server 101 may automatically modify or adjust one or more of the existing calendared events accordingly.

According to embodiments of the present invention, a template may consist of any of a variety of items related to an objective and may require (e.g., by prompting) additional information in order to complete and calendar events based on the template. For example, for an objective of “customer demo”, a template may require additional information such as, for example, date of the demo, name of lead technical person, name of any other technical persons involved, name of responsible salesman, name of responsible executive. Further, items/events that may be calendared based on a “customer demo” related template may include, for example, requirements meeting 3 weeks before date of demo with all parties except executive, checkpoint meeting 2 weeks before date with all parties except sales and executive, dry run and approval meeting 1 week before the demo with all parties, etc. If the checkpoint meeting is delayed, the date of the dry run may not move. However, if the requirements meeting is delayed, the date of the checkpoint meeting may move. The server may send an email to the lead technical person after the scheduled checkpoint meeting, and request a status which may be then published into an invite for the dry run.

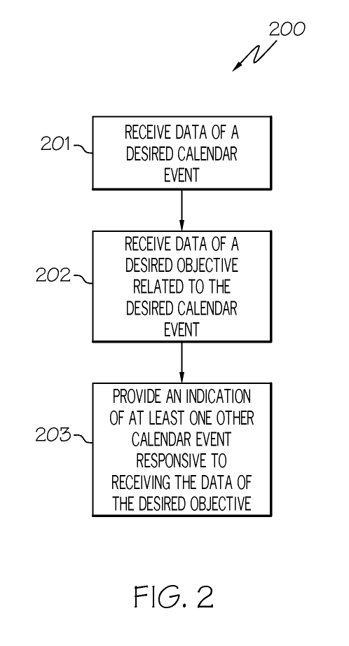

FIG. 2 shows a flowchart of a process for collaborative calendaring of event management according to an exemplary embodiment of the present invention. In the process 200, in block 201, data of a desired calendar event may be received. In block 202, data of a desired objective related to the calendar event may be received. In block 203, an indication of at least one other calendar event may be provided responsive to receiving the data of the desired objective. In one embodiment, the user receives the indication of the at least one other calendar event through a change in the display (controlled by the GUI) on the screen of the workstation.

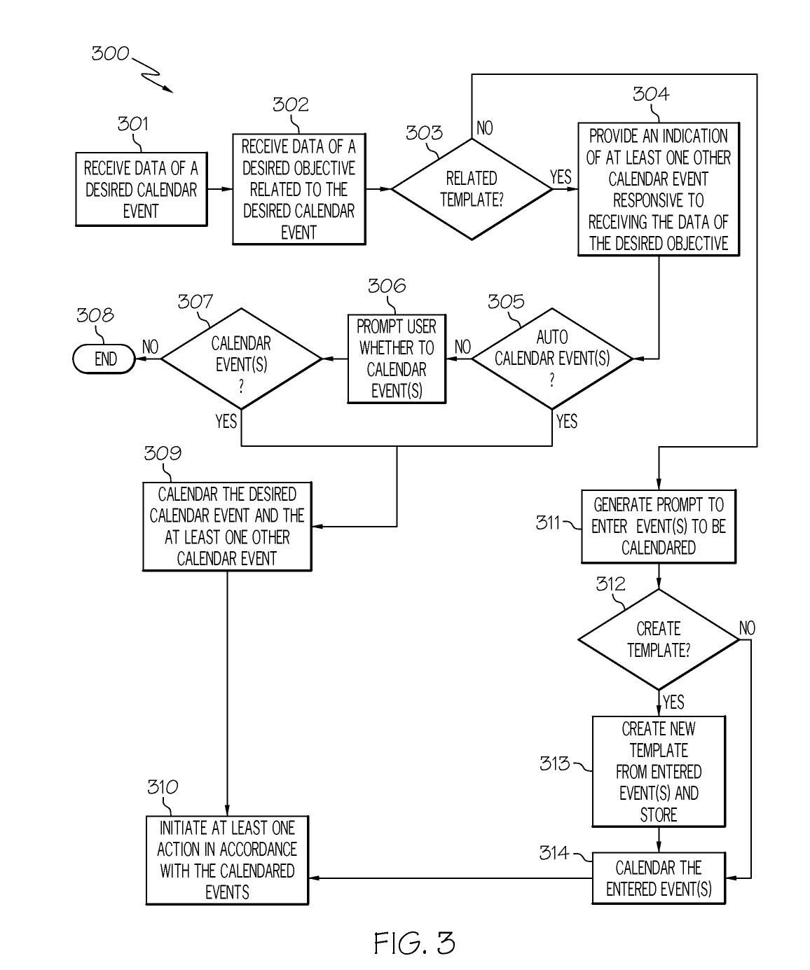

FIG. 3 shows a flowchart of a process for collaborative calendaring of event management according to another exemplary embodiment of the present invention. In the process 300, in block 301, data of a desired calendar event may be received. In one embodiment, data of a desired calendar event is received when a user requests a new calendar entry. In block 302, data of a desired objective related to the desired calendar event may be received. For example, the objective related to the calendar event may be “customer demo”. In block 303 it may be determined if a template exists that is related to the desired calendar activity and if so, in block 304, an indication of one or more other calendar events may be provided responsive to receiving the data of the desired objective. The one or more other calendar events may come from the template. In the example of the “customer demo” objective, an indication may be provided of a calendar event for “dry run”. In block 305 it may be determined if automatic calendaring of events has been set and if so then in block 309 the desired calendar event and the at least one other calendar event may be calendared. Then in block 310, one or more actions may be set for initiation or initiated in accordance with the calendared events. In this regard, actions may be initiated after calendaring of an event or may be set to be initiated at a later time based on a calendared event.

If it is determined that automatic calendaring of events has not been set then in block 306 a prompt may be generated and sent to a user asking whether the user wants to calendar one or more of the events. The user may elect to calendar all events or just selected events. Then in block 307 it may be determined if the user wants to calendar any events and if not then in block 308 the process ends. If the user wants to calendar one or more of the events, then in block 309 the desired calendar event and the at least one other calendar event may be calendared. Then in block 310 one or more actions may be set for initiation or initiated in accordance with the calendared events.

If in block 303 it is determined that a template does not exist that is related to the desired calendar activity, then in block 311, a prompt may be generated to enter one or more events to be calendared. A user may respond to the prompt by entering one or more events that the user wants to calendar based on the desired objective. Then in block 312, a prompt may be generated requesting whether it is desired to create a new template from the entered events and if not, in block 314 the entered one or more events may be calendared and then in block 310 one or more actions may be set for initiation or initiated in accordance with the calendared events. If it is desired to create a new template from the entered events then in block 313 a new template may be created from the one or more entered events and then stored. The new stored template may be now used by others if data of a desired objective related to the new template is subsequently received. In addition, although not shown, additional data may be received. For example, the template may generate one or more prompts requesting additional information. This additional information may be required or useful to help with appropriate calendaring (e.g., all necessary info is included) one or more events or setting up initiation of actions based on one or more calendared events.

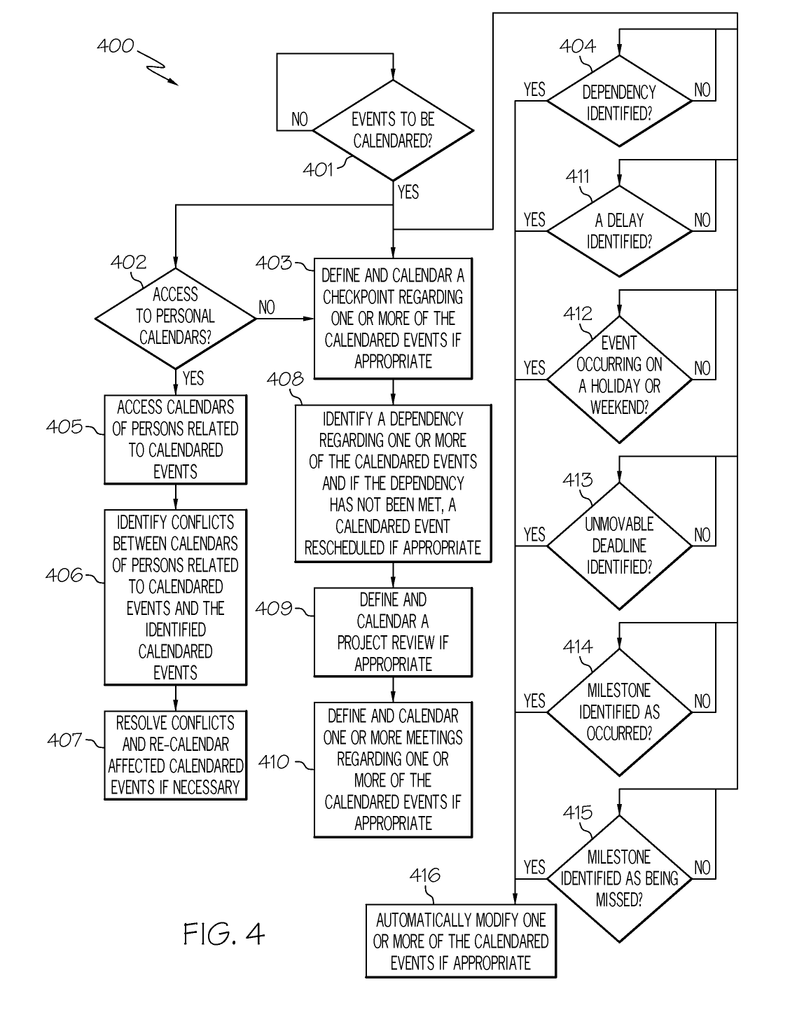

FIG. 4 shows a flowchart of a process for collaborative calendaring of event management according to a still further exemplary embodiment of the present invention. In the process 400, in block 401, it may be determined that if there are events to be calendared and if not, the process ends. If there are events to be calendared, multiple activities may occur such as, for example, in block 402, it may be determined whether access to the personal calendars of related individuals is available, in block 403, a check point may be defined and calendared regarding one or more of the calendared events if appropriate, and in blocks 404-415, activities may be identified which may require modification of existing calendared events.

In block 402, if access to personal calendars is not available, then in block 403, a check point may be defined and calendared regarding one or more of the calendared events if appropriate. If access to personal calendars is available, then in block 405, calendars of persons related to the calendared events may be accessed. Then in block 406, conflicts between calendars of persons related to the calendared events and the identified calendared events may be identified and in block 407, these conflicts may be resolved and affected calendared events re-calendared or modified if necessary. In block 403, after a check point has been defined and calendared, in block 408, a dependency regarding one or more of the calendared events may be identified and if the dependency has not been met, a calendared event rescheduled, if appropriate. In block 409, a project review may be defined and calendared if appropriate. In block 410, one or more meetings regarding one or more of the calendared events may be defined and calendared if appropriate.

Further, one or more activities or occurrences may required modification of existing calendared events. For example, in block 404, a dependency may be identified, in block 411 a delay may be identified, in block 412, an event occurring on a holiday or weekend may be determined, in block 413, an unmovable deadline may be identified, in block 414, a milestone may be identified as having occurred, in block 415, a milestone may be identified as having been missed, etc. Under one or more of these circumstances one or more of the calendared events may be automatically modified if appropriate. Modification may include, for example, changing a date of a calendared event, canceling a calendared event, adding a new a calendared event, changing a status of a calendared event, etc. In addition, activities or actions may also be initiated based on one or more activities or occurrences such as, for example, sending an email, setting up a meeting, notifying individuals of a meeting, leaving a voice message, sending a text message, etc.

According to embodiments of the present invention, a server may initially lay out the required meetings and calendar them. The server may then periodically check whether a scheduled event had occurred, and if so would take action per a template (e.g., reschedule, not reschedule, publish, etc.) Accessing personal calendars may occur during the calendaring of the meetings, as well as other activities, for example, holidays and weekend identification. Once all the data had been received per the template, many activities may occur such as for example, a date may be determined for an event, verification that the date is adequate may occur (e.g., no weekends, etc.), determine a time for calendared events, check the personal calendars of related or required persons if possible, and either modify a date and time, or else create a calendar entry and issue invitations to the participants. Periodically, the server may check if a milestone had been missed, (perhaps by sending a querying email), or if other change occurred (e.g., user changed a date).

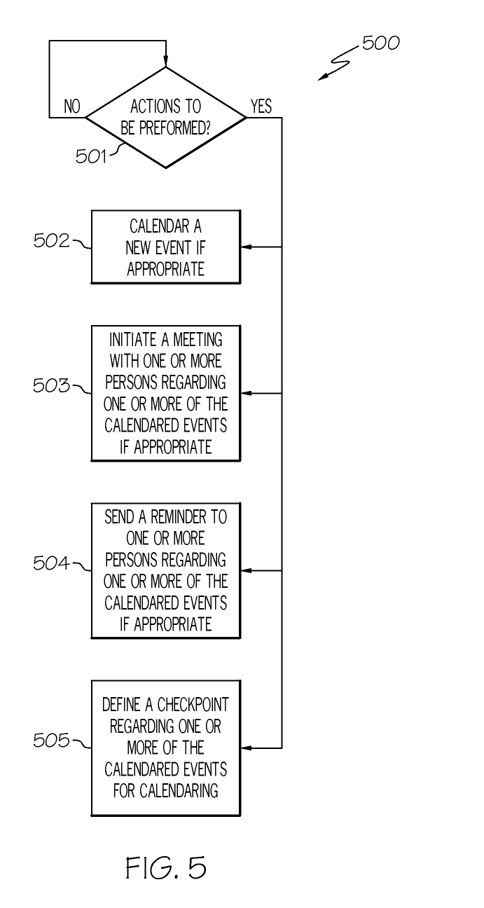

FIG. 5 shows a flowchart of a process for collaborative calendaring of event management according to a still further exemplary embodiment of the present invention. In the process 500 in block 501, it may be determined if actions are to be performed and if not, the process ends. If there are actions to be performed, one or more of various types of actions may be automatically performed based on the calendared events. For example, in block 502, a new event may be calendared if appropriate, in block 503, a meeting may be initiated with one or more persons regarding one or more of the calendared events if appropriate, in block 504, a reminder may be sent to one or more persons regarding one or more of the calendared events if appropriate, in block 505, a check point may be defined regarding one or more of the calendared events for calendaring, etc.

Therefore, according to embodiments of the present invention, a user may define an objective and events automatically calendared and activities or actions automatically initiated based on the calendared events. This includes any of many types of activities such as, for example, setting up meetings, defining milestones, sending emails, sending reminders, automatically changing calendared events, notifying affected or appropriate individuals, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method operable on a server for collaborative calendaring of event management comprising:
receiving, by the server, data of a desired calendar event;
receiving, by the server, data of a desired objective related to the desired calendar event; and
providing, by the server, an indication of at least one other calendar event responsive to receiving the data of the desired objective.

2. The method according to claim 1, further comprising calendaring, by the server, the desired calendar event and the at least one other calendar event.

3. The method according to claim 2, further comprising automatically modifying, by the server, at least one of the at least one other calendar events responsive to at least one of a dependency, a delay, a calendar of a person, a calendared event occurring on a holiday, a calendared event occurring on a Saturday or Sunday, an unmovable deadline, a milestone occurring, and a milestone being missed.

4. The method according to claim 2, further comprising initiating, by the server, at least one action in accordance with the at least one other calendar event.

5. The method according to claim 4, wherein the at least one action comprises at least one of calendaring a new event, sending a notification of a meeting to at least one person, sending a reminder to at least one person regarding at least one of the calendared events, defining and calendaring a checkpoint regarding at least one of the calendared events, identifying a dependency, rescheduling an event based on a status of a dependency, and defining and calendaring a project review.

6. The method according to claim 1, wherein the indication of the at least one other calendar event is provided based on a template associated with the desired objective.

7. The method according to claim 6, wherein the template defines best practices events related to the objective.

8. The method according to claim 6, further comprising receiving, by the server, additional data required by the template.

9. The method according to claim 1, wherein the desired objective comprises a desired project management objective.

10. The method according to claim 1, further comprising identifying, by the server, at least one person related to at least one of the calendared events based on the received data.

11. A computing device comprising:
a network interface, the network interface being configured to receive data of a desired calendar event and data of a desired objective related to the desired calendar event;
a storage device, the storage device containing at least one template associated with an objective; and
a processor, the processor entering the received data of the desired calendar event, processing the received data of the desired objective, and providing an indication of at least one other calendar event responsive to processing the data of the desired objective.

12. The computing device according to claim 11, further comprising the processor calendaring the desired calendar event and the at least one other calendar event.

13. The computing device according to claim 12, further comprising the processor automatically modifying at least one of the at least one other calendar events responsive to at least one of a dependency, a delay, a calendar of a person, a calendared event occurring on a holiday, a calendared event occurring on a Saturday or Sunday, an unmovable deadline, a milestone occurring, and a milestone being missed.

14. The computing device according to claim 12, further comprising the processor initiating at least one action in accordance with the at least one other calendar event.

15. The computing device according to claim 14, wherein the at least one action comprises at least one of calendaring a new event, initiating a meeting with at least one person, sending a reminder to at least one person regarding at least one of the calendared events, defining and calendaring a checkpoint regarding at least one of the calendared events, identifying a dependency, rescheduling an event based on a status of a dependency, and defining and calendaring a project review.

16. The computing device according to claim 11, wherein the indication of the at least one other calendar event is provided based on a template associated with the desired objective.

17. A computer program product comprising a computer readable storage medium, the computer readable storage medium having computer readable program code embodied therewith, the computer readable storage medium comprising:
computer readable program code configured to receive data of a desired calendar event;
computer readable program code configured to receive data of a desired objective related to the desired calendar event; and
computer readable program code configured to provide an indication of at least one other calendar event responsive to receiving the indication of the desired objective.

18. The computer program product according to claim 17, further comprising computer readable program code configured to calendar the desired calendar event and the at least one other calendar event responsive to one of receiving authorization to calendar the desired calendar event and the at least one other calendar event and automatically.

19. The computer program product according to claim 18, further comprising computer readable program code configured to automatically modify at least one of the at least one other calendar events responsive to at least one of a dependency, a delay, a calendar of a person, a calendared event occurring on a holiday, a calendared event occurring on a Saturday or Sunday, an unmovable deadline, a milestone occurring, and a milestone being missed.

20. The computer program product according to claim 18, further comprising computer readable program code configured to initiate at least one action in accordance with the at least one other calendar event.
